(19) United States
(12) Patent Application Publication
(10) Pub. No.: US 2024/0276269 A1
(43) Pub. Date: Aug. 15, 2024

(54) MEASUREMENT CONTROL WITH LOW POWER WAKEUP SIGNALS

(71) Applicant: Samsung Electronics Co., Ltd.S, Suwon-si (KR)

(72) Inventors: Kyeongin Jeong, Allen, TX (US); Hongbo Si, Allen, TX (US); Shiyang Leng, Allen, TX (US)

(21) Appl. No.: 18/435,139

(22) Filed: Feb. 7, 2024

Related U.S. Application Data
(60) Provisional application No. 63/445,593, filed on Feb. 14, 2023.

(51) Int. Cl. H04W 24/10; H04W 52/02

(52) U.S. Cl. CPC H04W 24/10; H04W 52/0229

(57) ABSTRACT

Methods and apparatuses for a measurement control operation with low power signals in a wireless communication system. A method of a UE comprises: receiving first and second signal; performing a measurement operation on the first signal of the serving cell: based on a determination that the measurement result of the first signal meets the first threshold, skipping the measurement operation on the second signal of the serving cell, and based on a determination that the measurement result of the first signal does not meet the first threshold: performing a measurement operation on the second signal of the serving cell, determining whether a measurement result of the second signal meets a second threshold, and based on a determination that the measurement result of the second signal of the serving cell meets the second threshold, skipping a measurement operation on a signal of a neighboring cell.

### CROSS-REFERENCE TO RELATED APPLICATIONS AND CLAIM OF PRIORITY

The present application claims priority to U.S. Provisional Patent Application No. 63/445,593, filed on Feb. 14, 2023. The contents of the above-identified patent documents are incorporated herein by reference.

### TECHNICAL FIELD

The present disclosure relates generally to wireless communication systems and, more specifically, the present disclosure relates to measurement control with low power signals in a wireless communication system.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to wireless communication systems and, more specifically, the present disclosure relates to measurement control with low power signals in a wireless communication system.

In one embodiment, a user equipment (UE) in a wireless communication system is provided. The UE comprises a transceiver configured to receive, from a base station (BS) of a serving cell, a first signal and a second signal. The UE further comprises a processor operably coupled to the transceiver, the processor configured to: perform a measurement operation on the first signal of the serving cell, determine whether a measurement result of the first signal meets a first threshold, based on a determination that the measurement result of the first signal meets the first threshold, skip the measurement operation on the second signal of the serving cell, and based on a determination that the measurement result of the first signal does not meet the first threshold: perform a measurement operation on the second signal of the serving cell, determine whether a measurement result of the second signal meets a second threshold, and based on a determination that the measurement result of the second signal of the serving cell meets the second threshold, skip a measurement operation on a signal of a neighboring cell.

In another embodiment, a method of a UE in a wireless communication system is provided. The method comprises: receiving, from a BS of a serving cell, a first signal and a second signal; performing a measurement operation on the first signal of the serving cell; and determining whether a measurement result of the first signal meets a first threshold: based on a determination that the measurement result of the first signal meets the first threshold, skipping the measurement operation on the second signal of the serving cell, and based on a determination that the measurement result of the first signal does not meet the first threshold: performing a measurement operation on the second signal of the serving cell, determining whether a measurement result of the second signal meets a second threshold, and based on a determination that the measurement result of the second signal of the serving cell meets the second threshold, skipping a measurement operation on a signal of a neighboring cell.

In yet another embodiment, a BS in a wireless communication system is provided. The BS comprises a processor and a transceiver operably coupled to the processor the transceiver configured to transmit, to a UE, a first signal and a second signal, wherein: a measurement operation is performed on the first signal of a serving cell including the BS, whether a measurement result of the first signal meets a first threshold is determined, based on a determination that the measurement result of the first signal meets the first threshold, the measurement operation is skipped on the second signal of the serving cell, and based on a determination that the measurement result of the first signal does not meet the first threshold: a measurement operation is performed on the second signal of the serving cell, whether a measurement result of the second signal meets a second threshold is determined, and based on a determination that the measurement result of the second signal of the serving cell meets the second threshold, a measurement operation is skipped on a signal of a neighboring cell.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of wireless network according to embodiments of the present disclosure;

FIG. 2 illustrates an example of gNB according to embodiments of the present disclosure;

FIG. 3 illustrates an example of UE according to embodiments of the present disclosure;

FIGS. 4 and 5 illustrate example of wireless transmit and receive paths according to this disclosure;

FIG. 6 illustrates an example of a signaling flow between a UE and a gNB according to embodiments of the present disclosure;

FIG. 7 illustrates a flowchart of a UE method according to embodiments of the present disclosure; and

FIG. 8 illustrates a flowchart of a UE method for measurement control with low power signals in a wireless communication system according to embodiments of the present disclosure.

### DETAILED DESCRIPTION

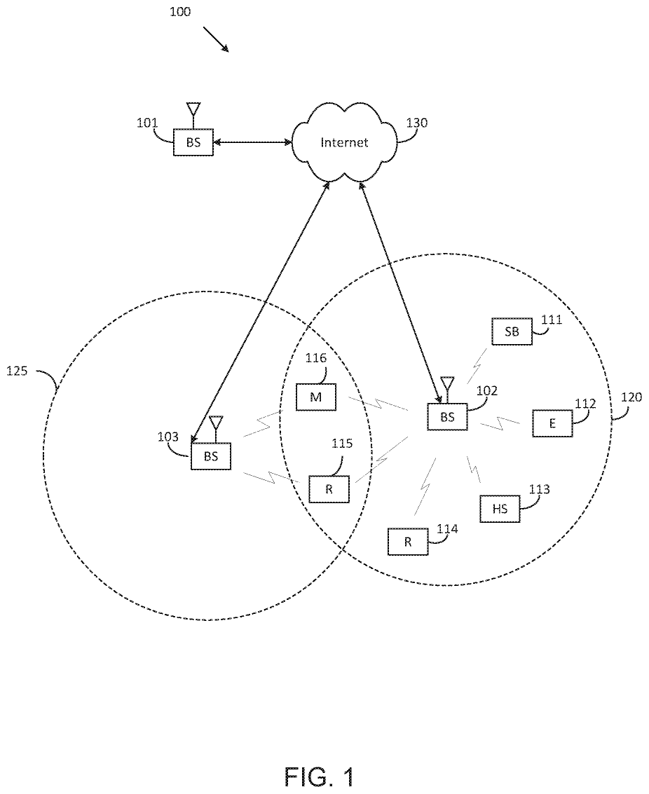

FIGS. 1 through 8, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

The following documents are hereby incorporated by reference into the present disclosure as if fully set forth herein: 3GPP TS 38.211 v17.4.0, “NR; Physical channels and modulation”; 3GPP TS 38.212 v17.4.0, “NR; Multiplexing and channel coding”; 3GPP TS 38.213 v17.4.0, “NR; Physical Layer Procedures for Control”; 3GPP TS 38.214 v17.4.0, “NR; Physical Layer Procedures for data”; 3GPP TS 38.304 v17.3.0, “NR; User Equipment (UE) procedures in idle mode and RRC inactive state”; 3GPP TS 38.331 v17.3.0, “NR; Radio Resource Control (RRC) protocol specification”; 3GPP TS 23.122 v17.9.0, “NAS functions related to Mobile Station (MS) in RRC IDLE state”; 3GPP TS 38.133 v17.8.0, “NR: Requirements for Support of Radio Resource Management”; and 3GPP TS 38.101-1 v17.8.0, “NR; User Equipment (UE) radio transmission and reception; Part 1: Range 1 Standalone.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for measurement control with low power signals in a wireless communication system. In certain embodiments, and one or more of the gNBs 101-103 includes circuitry, programing, or a combination thereof, to support measurement control with low power signals in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

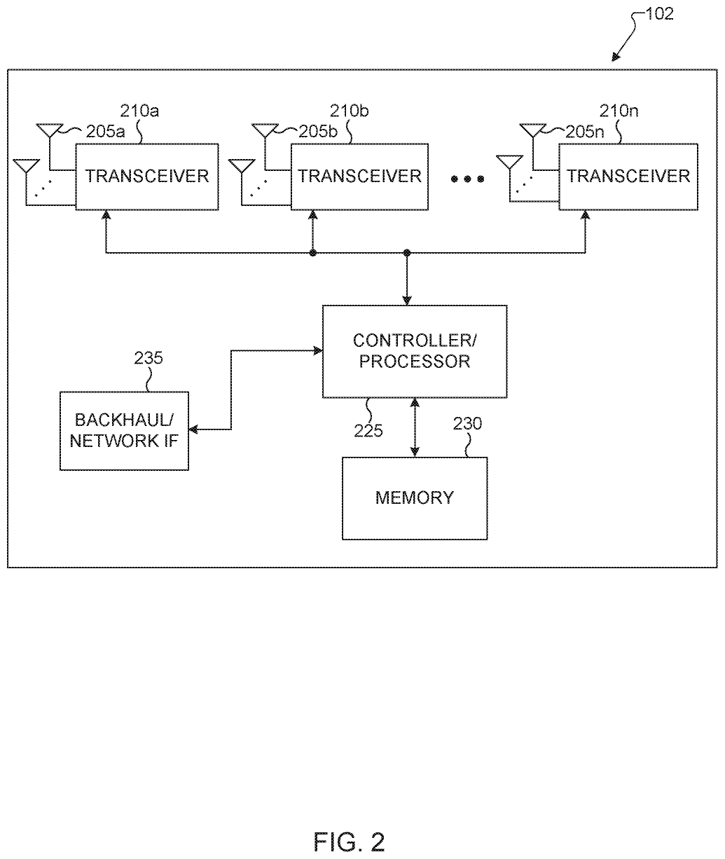

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as an OS. The controller/processor 225 can move data into or out of the memory 230 as required by an executing process. The controller/processor 225 is also capable of executing programs and other processes resident in the memory 230, such as processes to support measurement control with low power signals in a wireless communication system.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

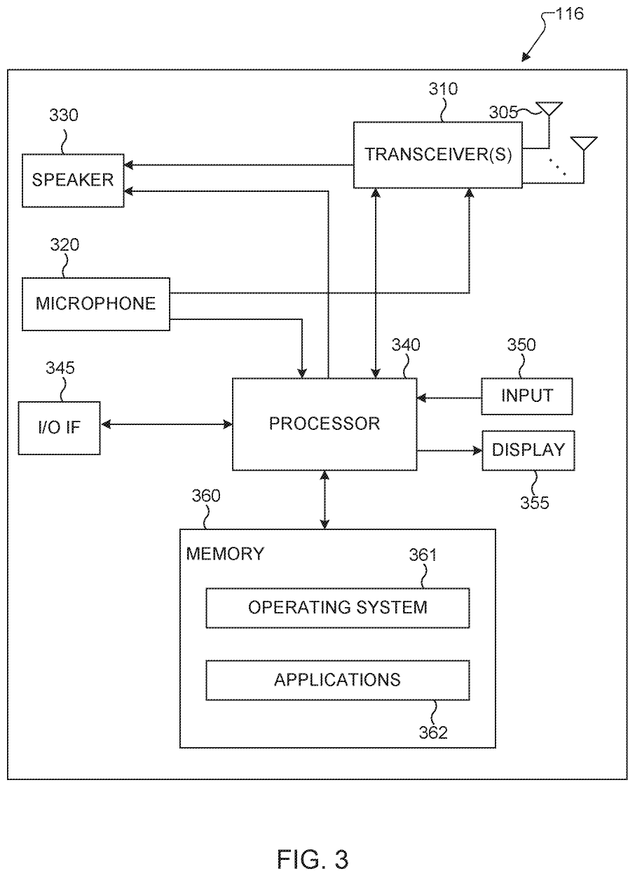

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, such as processes for measurement control with low power signals in a wireless communication system. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

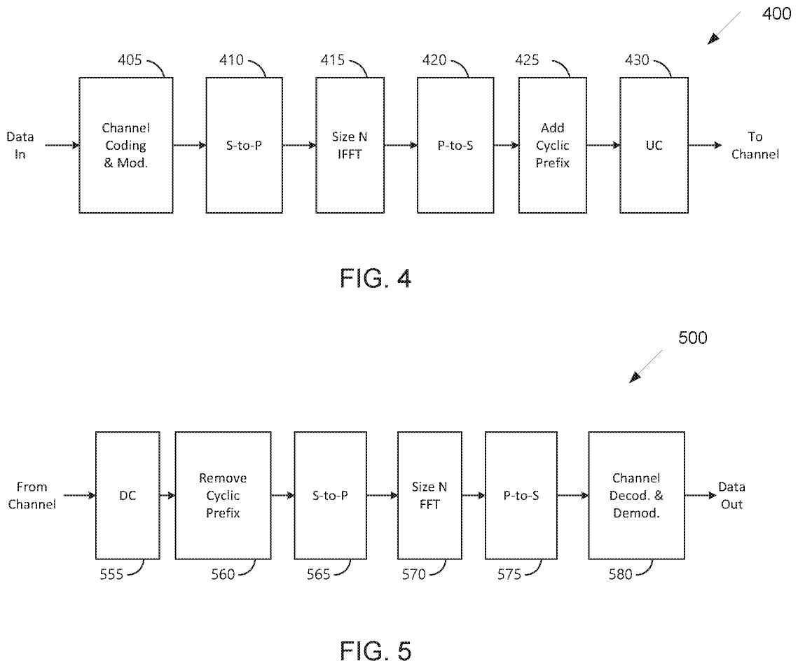

FIG. 4 and FIG. 5 illustrate example wireless transmit and receive paths according to this disclosure. In the following description, a transmit path 400 may be described as being implemented in a gNB (such as the gNB 102), while a receive path 500 may be described as being implemented in a UE (such as a UE 116). However, it may be understood that the receive path 500 can be implemented in a gNB and that the transmit path 400 can be implemented in a UE. In some embodiments, the receive path 500 is configured to support measurement control with low power signals in a wireless communication system.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down- converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116.

As illustrated in FIG. 5, the down-converter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNBs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the gNBs 101-103 and may implement the receive path 500 for receiving in the downlink from the gNBs 101-103.

Each of the components in FIG. 4 and FIG. 5 can be implemented using only hardware or using a combination of hardware and software/firmware. As a particular example, at least some of the components in FIGS. 4 and FIG. 5 may be implemented in software, while other components may be implemented by configurable hardware or a mixture of software and configurable hardware. For instance, the FFT block 570 and the IFFT block 415 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

In 3GPP wireless standards, new radio (NR, radio access technology (RAT)) has been specified as 5G wireless communication. One of NR features is UE power saving. NR supported discontinuous reception (DRX) for a UE in either RRC idle/inactive mode/state or RRC connected state, such that the UE could stop receiving signals or channels during DRX inactive time periods within a DRX cycle and save power consumption. In Rel-16, an enhancement towards DRX for RRC connected state (C-DRX) was introduced, wherein a new DCI format was used to help the UE to skip a DRX on-duration within a C-DRX cycle such that further power saving gain could be achieved.

In Rel-17, enhancement towards DRX for RRC idle/inactive mode/state was introduced, wherein a paging early indication (PEI) was used for a UE to skip monitoring paging occasions such that extra power saving gain could be achieved. However, in order for the UE to monitor a new DCI format where includes PEI, the UE still needs to perform synchronization and/or measurements based on synchronization signal block (SSB) and decode PDCCH according to PEI monitoring/reception occasion in time domain, such that the radio of the UE cannot be fully turned off for a long-time duration. To avoid such situation and to acquire further power saving gain, an additional radio receiver is considered, wherein the additional radio receiver can be used only for monitoring a particular set of signals with very low power consumption (hereafter the particular set of signals is also called as low-power wake-up signal (LP-WUS), and the main radio receiver can be turned off or operating with a very low power for a long time duration.

That particular set of signals may also include a kind of compact synchronization signal and/or measurement reference signal, so the particular set of signals can be also used for measurement purpose. This disclosure focuses on the measurement control for serving cell and/or neighboring cells with LP-WUS that could be received by the additional radio receiver.

In 3GPP standard specification, with current NR synchronization signal block (SSB), measurement rules for cell reselection are defined as follow in TABLE 1.

TABLE 1
NR SSB measurement rules

Srxlev = Qᵣₓₗₑᵥₘₑₐₛ − (Qᵣₓₗₑᵥₘᵢₙ + Q_{rxlevminoffset}) −
P_{compensation} − Qoffsetₜₑₘₚ
Squal = Q_{qualmeas} − (Q_{qualmin} + Q_{qualminoffset}) − Qoffsetₜₑₘₚ

For TABLE 1, following parameters are provided as shown in TABLE 2.

TABLE 2
Parameters for TABLE 1

| | |
|---|---|
| Srxlev | Cell selection RX level value (dB) |
| Squal | Cell selection quality value (dB) |
| Qoffsetₜₑₘₚ | Offset temporarily applied to a cell as specified in 3GPP |
| | standard specification (dB) |
| Qᵣₓₗₑᵥₘₑₐₛ | Measured cell RX level value (RSRP) |
| Q_{qualmeas} | Measured cell quality value (RSRQ) |
| Qᵣₓₗₑᵥₘᵢₙ | Minimum required RX level in the cell (dBm). If the UE supports SUL |
| | frequency for this cell, Qᵣₓₗₑᵥₘᵢₙ is obtained from q-RxLevMinSUL, if present, in |
| | SIB1, SIB2 and SIB4, additionally, if Q_{rxlevminoffsetcellSUL} is present in SIB3 and |
| | SIB4 for the concerned cell, this cell specific offset is added to the corresponding |
| | Qrxlevmin to achieve the required minimum RX level in the concerned cell; |
| | else Qᵣₓₗₑᵥₘᵢₙ is obtained from q-RxLevMin in SIB1, SIB2 and SIB4, additionally, |
| | if Q_{rxlevminoffsetcell} is present in SIB3 and SIB4 for the concerned cell, this cell |
| | specific offset is added to the corresponding Qrxlevmin to achieve the required |
| | minimum RX level in the concerned cell. |
| Q_{qualmin} | Minimum required quality level in the cell (dB). Additionally, if Q_{qualminoffsetcell} is |
| | signalled for the concerned cell, this cell specific offset is added to achieve the |
| | required minimum quality level in the concerned cell. |
| Q_{rxlevminoffset} | Offset to the signalled Qᵣₓₗₑᵥₘᵢₙ taken into account in the Srxlev evaluation as a |
| | result of a periodic search for a higher priority PLMN while camped normally in |
| | a VPLMN, as specified in 3GPP standard specification. |
| Q_{qualminoffset} | Offset to the signalled Q_{qualmin} taken into account in the Squal evaluation as a |
| | result of a periodic search for a higher priority PLMN while camped normally in |
| | a VPLMN, as specified in 3GPP standard specification. |
| P_{compensation} | For FR1, if the UE supports the additionalPmax in the NR-NS-PmaxList, if |
| | present, in SIB1, SIB2 and SIB4: max(P_{EMAX1} − P_{PowerClass}, 0) − (min(P_{EMAX2}, |
| | P_{PowerClass}) − min(P_{EMAX1}, P_{PowerClass})) (dB); |
| | else: max(P_{EMAX1} − P_{PowerClass}, 0) (dB) |
| | For FR2, P_{compensation} is set to 0. |
| | For IAB-MT, P_{compensation} is set to 0. |
| P_{EMAX1}, | Maximum TX power level of a UE may use when transmitting on the uplink in |
| P_{EMAX2} | the cell (dBm) defined as P_{EMAX} in 3GPP standard specification. If UE supports |
| | SUL frequency for this cell, P_{EMAX1} and P_{EMAX2} are obtained from the p-Max for |
| | SUL in SIB1 and NR-NS-PmaxList for SUL respectively in SIB1, SIB2 and SIB4 |
| | as specified in 3GPP standard specification, else P_{EMAX1} and P_{EMAX2} are obtained |
| | from the p-Max and NR-NS-PmaxList respectively in SIB1, SIB2 and SIB4 for |
| | normal UL as specified in 3GPP standard specification. |
| P_{PowerClass} | Maximum RF output power of the UE (dBm) according to the UE power class as |
| | defined in 3GPP standard specification. |

In the present disclosure, following operations are provided for measurement rules for

a cell reselection operation.

TABLE 3
Measurement rules for cell re-selection

Measurement rules for cell re-selection
Following rules are used by the UE to limit needed measurements:

| - | If the serving cell fulfils Srxlev > S_{IntraSearchP} and Squal > S_{IntraSearchQ}: | |
|---|---|---|
| | - | If distanceThresh and referenceLocation are broadcasted in SIB19, and if UE supports |

| location-based measurement initiation and has obtained its location information: | |
|---|---|
| - | If the distance between UE and the serving cell reference location |
| | referenceLocation is shorter than distanceThresh, the UE may not perform intra- |
| | frequency measurements; |
| - | Else, the UE shall perform intra-frequency measurements; |

| | - | Else, the UE may not perform intra-frequency measurements; |
|---|---|---|
| - | Else, the UE shall perform intra-frequency measurements. | |
| - | The UE shall apply the following rules for NR inter-frequencies and inter-RAT | |
| | frequencies which are indicated in system information and for which the UE has priority | |
| | provided: | |
| | - | For a NR inter-frequency or inter-RAT frequency with a reselection priority higher |
| | | than the reselection priority of the current NR frequency, the UE shall perform |
| | | measurements of higher priority NR inter-frequency or inter-RAT frequencies |
| | | according to 3GPP standard specification. |
| | - | For a NR inter-frequency with an equal or lower reselection priority than the reselection |

| priority of the current NR frequency and for inter-RAT frequency with lower | |
|---|---|
| reselection priority than the reselection priority of the current NR frequency: | |
| - | If the serving cell fulfils Srxlev > S_{nonIntraSearchP} and Squal > S_{nonIntraSearchQ}: |

| | |
|---|---|
| - | If distanceThresh and referenceLocation are broadcasted in SIB19, and if UE |

| supports location-based measurement initiation and has obtained its UE location | |
|---|---|
| information: | |
| - | If the distance between UE and the serving cell reference location |
| | referenceLocation is shorter than distanceThresh, the UE may choose not to |
| | perform measurements of NR inter-frequency cells of equal or lower |
| | priority, or inter-RAT frequency cells of lower priority; |
| - | Else, the UE shall perform measurements of NR inter-frequency cells of |

equal or lower priority, or inter-RAT frequency cells of lower priority
according to 3GPP standard specification;

| | |
|---|---|
| - | Else, the UE may choose not to perform measurements of NR inter-frequency |

cells of equal or lower priority, or inter-RAT frequency cells of lower priority;

| | |
|---|---|
| - | Else, the UE shall perform measurements of NR inter-frequency cells of equal or |

lower priority, or inter-RAT frequency cells of lower priority according to 3GPP
standard specification.

| | |
|---|---|
| - | If the UE supports relaxed measurement and relaxedMeasurement is present in SIB2, the |
| | UE may further relax the needed measurements, as specified in 3GPP standard |
| | specification. |

If the t-Service of the serving cell is present in SIB19, and if UE supports time-based
measurement initiation, the UE shall perform intra-frequency, inter-frequency or inter-RAT
measurements before the t-Service, regardless of the distance between UE and the serving cell
reference location or whether the serving cell fulfils Srxlev > S_{IntraSearchP} and Squal > S_{IntraSearchQ},
or Srxlev > S_{nonIntraSearchP} and Squal > S_{nonIntraSearchQ}, The exact time to start measurement before
t-Service is up to UE implementation. UE shall perform measurements of higher priority NR
inter-frequency or inter-RAT frequencies according to 3GPP standard specification regardless
of the remaining service time of the serving cell (i.e., time remaining until t-Service).

| | |
|---|---|
| NOTE: | When evaluating the distance between UE and the serving cell reference location, |

it's up to UE implementation to obtain UE location information.

TABLE 4
Relaxed Measurement

Relaxed measurement
Relaxed measurement rules
When the UE is required to perform measurements of intra-frequency cells or NR inter-
frequency cells or inter-RAT frequency cells according to the measurement rules in 3GPP
standard specification:

| - | if lowMobilityEvaluation is configured and cellEdgeEvaluation is not configured; and | |
|---|---|---|
| - | if the UE has performed normal intra-frequency, NR inter-frequency, or inter-RAT | |
| | frequency measurements for at least T_{SearchDeltaP} after (re-)selecting a new cell; and | |
| - | if the relaxed measurement criterion in 3GPP standard specification is fulfilled for a period | |
| | of T_{SearchDeltaP}: | |
| | - | the UE may choose to perform relaxed measurements for intra-frequency cells, NR |
| | | inter-frequency cells or inter-RAT frequency cells according to relaxation methods in |
| | | 3GPP standard specification; |
| - | if cellEdgeEvaluation is configured and lowMobilityEvaluation is not configured; and | |
| - | if the relaxed measurement criterion in 3GPP standard specification is fulfilled: | |
| | - | the UE may choose to perform relaxed measurements for intra-frequency cells |
| | | according to relaxation methods in 3GPP standard specification; |
| | - | if the serving cell fulfils Srxlev ≤ S_{nonIntraSearchP} or Squal ≤ S_{nonIntraSearchQ}: |

| | |
|---|---|
| - | the UE may choose to perform relaxed measurements for NR inter-frequency cells |

or inter-RAT frequency cells according to relaxation methods in 3GPP standard
specification;

| - | if both lowMobilityEvaluation and cellEdgeEvaluation are configured: | |
|---|---|---|
| | - | if the UE has performed normal intra-frequency, NR inter-frequency, or inter-RAT |
| | | frequency measurements for at least T_{SearchDeltaP} after (re-)selecting a new cell; and |
| | - | if the relaxed measurement criterion in 3GPP standard specification is fulfilled for a |
| | | period of T_{SearchDeltaP}; and |
| | - | if the relaxed measurement criterion in 3GPP standard specification is fulfilled: |

| | |
|---|---|
| - | the UE may choose to perform relaxed measurements for NR intra-frequency cells, |

inter-frequency cells or inter-RAT frequency cells according to relaxation methods
in 3GPP standard specification;

| | |
|---|---|
| - | else: |

| - | if the UE has performed normal intra-frequency, NR inter-frequency, or inter-RAT |
|---|---|
| | frequency measurements for at least T_{SearchDeltaP} after (re-)selecting a new cell, and |
| | the relaxed measurement criterion in 3GPP standard specification is fulfilled for a |
| | period of T_{SearchDeltaP}; Or, |
| - | if the relaxed measurement criterion in 3GPP standard specification is fulfilled: |

| | |
|---|---|
| - | if combineRelaxedMeasCondition is not configured: |

| - | the UE may choose to perform relaxed measurements for intra-frequency |
|---|---|
| | cells, NR inter-frequency cells of equal or lower priority, or inter-RAT |
| | frequency cells of lower priority according to relaxation methods in 3GPP |
| | standard specification; |
| - | if the serving cell fulfils Srxlev ≤ S_{nonIntraSearchP} or Squal ≤ S_{nonIntraSearchQ}: |

| | |
|---|---|
| - | the UE may choose to perform relaxed measurement for NR inter- |

frequency cells of higher priority, or inter-RAT frequency cells of higher
priority according to relaxation methods in 3GPP standard specification;

| - | if the UE is a RedCap UE; and | |
|---|---|---|
| - | if stationaryMobilityEvaluation is configured and cellEdgeEvaluationWhileStationary is | |
| | not configured; and | |
| - | if the UE has performed normal intra-frequency, NR inter-frequency, or inter-RAT | |
| | frequency measurements for at least T_{SearchDeltaP-Stationary} after (re-)selecting a new cell; and | |
| - | if the relaxed measurement criterion in 3GPP standard specification is fulfilled for a period | |
| | of T_{SearchDeltaP-Stationary}: | |
| | - | the UE may choose to perform relaxed measurements for intra-frequency cells, NR |
| | | inter-frequency cells, or inter-RAT frequency cells according to relaxation methods in |
| | | 3GPP standard specification; |
| - | if the UE is a RedCap UE; and | |
| - | if both stationaryMobilityEvaluation and cellEdgeEvaluationWhileStationary are | |
| | configured: | |
| | - | if the UE has performed normal intra-frequency, NR inter-frequency, or inter-RAT |
| | | frequency measurements for at least T_{SearchDeltaP-Stationary} after (re-)selecting a new cell; |
| | | and |
| | - | if the relaxed measurement criterion in 3GPP standard specification is fulfilled: |

| | |
|---|---|
| - | the UE may choose to perform relaxed measurements for intra-frequency cells, NR |

inter-frequency cells, or inter-RAT frequency cells according to relaxation
methods in 3GPP standard specification;

| | |
|---|---|
| - | else: |

| | |
|---|---|
| - | if combineRelaxedMeasCondition2 is not configured: |

| - | if the UE has performed normal intra-frequency, NR inter-frequency, or inter- |
|---|---|
| | RAT frequency measurements for at least T_{SearchDeltaP-Stationary} after (re-)selecting |
| | a new cell; and |
| - | if the relaxed measurement criterion in 3GPP standard specification is fulfilled |

| for a period of T_{SearchDeltaP-Stationary}. | |
|---|---|
| - | the UE may choose to perform relaxed measurements for intra-frequency |

cells, NR inter-frequency cells, or inter-RAT frequency cells according to
relaxation methods in 3GPP standard specification;

| | |
|---|---|
| NOTE 1: | It is up to UE implementation when to start performing relaxed measurements |

in RRC Idle/Inactive if multiple methods are configured.

| | |
|---|---|
| NOTE 2: | It is up to UE implementation which relaxation method to perform based on the |

“allowed” cases as specified in 3GPP standard specification for RRC Idle/Inactive
if multiple methods are configured.

The above relaxed measurements and no measurement are not applicable for frequencies that are included in VarMeasIdleConfig. if configured and for which the UE supports dual connectivity or carrier aggregation between those frequencies and the frequency of the current serving cell.

TABLE 5
Relaxed measurement criterion

Relaxed measurement criterion for UE with low mobility
The relaxed measurement criterion for UE with low mobility is fulfilled when:

| | |
|---|---|
| - | (Srxlev_{Ref} − Srxlev) < S_{SearchDeltaP}, |

Where:

| - | Srxlev = current Srxlev value of the serving cell (dB). | |
|---|---|---|
| - | Srxlev_{Ref} = reference Srxlev value of the serving cell (dB), set as follows: | |
| | - | After selecting or reselecting a new cell, or |
| | - | If (Srxlev − Srxlev_{Ref}) > 0, or |
| | - | If the relaxed measurement criterion has not been met for T_{SearchDeltaP}: |

| | |
|---|---|
| - | The UE shall set the value of Srxlev_{Ref} to the current Srxlev value of the serving |

cell.

TABLE 6
Relaxed measurement criterion

| Relaxed measurement criterion for UE not at cell edge | |
|---|---|
| The relaxed measurement criterion for UE not at cell edge is fulfilled when: | |
| - | Srxlev > S_{SearchThresholdP}, and, |
| - | Squal > S_{SearchThresholdQ}, if S_{SearchThresholdQ} is configured, |
| Where: | |
| - | Srxlev = current Srxlev value of the serving cell (dB). |
| - | Squal = current Squal value of the serving cell (dB). |

TABLE 7
Relaxed measurement criterion

Relaxed measurement criterion for a stationary RedCap UE
The relaxed measurement criterion for a stationary RedCap UE is fulfilled when:

| | |
|---|---|
| - | (Srxlev_{RefStationary} − Srxlev) < S_{SearchDeltaP-Stationary}, |

Where:

| - | Srxlev = current Srxlev value of the serving cell (dB). | |
|---|---|---|
| - | Srxlev_{RefStationary} = reference Srxlev value of the serving cell (dB), set as follows: | |
| | - | After selecting or reselecting a new cell, or |
| | - | If (Srxlev − Srxlev_{RefStationary}) > 0, or |
| | - | If the relaxed measurement criterion has not been met for T_{SearchDeltaP-Stationary}: |

| | |
|---|---|
| - | The UE shall set the value of Srxlev_{RefStationary} to the current Srxlev value of the |

serving cell.

TABLE 8
Relaxed measurement criterion

Relaxed measurement criterion for a stationary RedCap UE not at cell edge
The relaxed measurement criterion for a stationary RedCap UE not at cell edge is fulfilled when:

| | |
|---|---|
| - | the relaxed measurement criterion in 3GPP standard specification is fulfilled for a period |
| | of T_{SearchDeltaP-Stationary}, |
| - | Srxlev > S_{SearchThresholdP2}, and, |
| - | Squal > S_{SearchThresholdQ2}, if S_{SearchThresholdQ2} is configured. |
| Where: | |
| - | Srxlev = current Srxlev value of the serving cell (dB). |
| - | Squal = current Squal value of the serving cell (dB). |

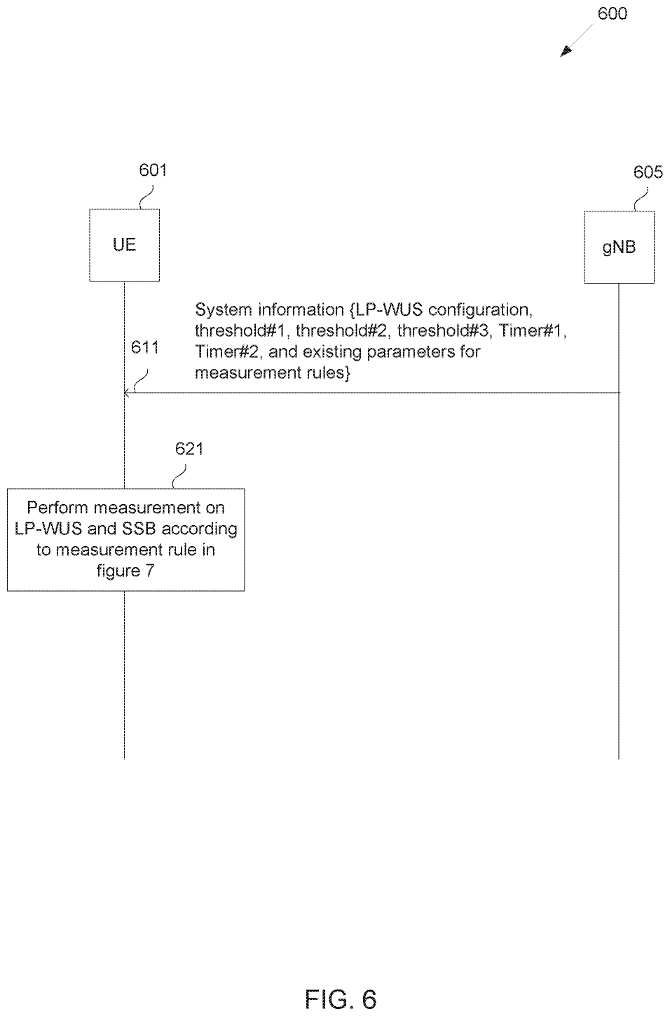

FIG. 6 illustrates an example of a signaling flows between a UE and a gNB according to embodiments of the present disclosure. The method signaling flow 600 as may be performed by a UE (e.g., 111-116 as illustrated in FIG. 1) and a base station (e.g., 101-103 as illustrated in FIG. 1). An embodiment of the signaling flow 600 shown in FIG. 6 is for illustration only. One or more of the components illustrated in FIG. 6 can be implemented in specialized circuitry configured to perform the noted functions or one or more of the components can be implemented by one or more processors executing instructions to perform the noted functions.

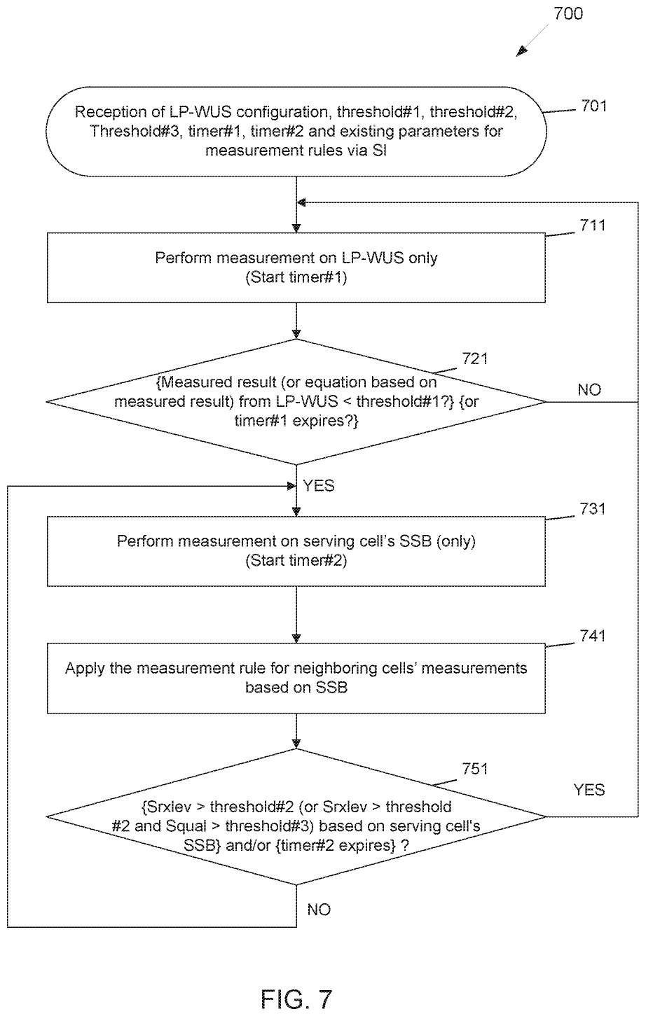

FIG. 7 illustrates a flowchart of a UE method according to embodiments of the present disclosure. The method 700 as may be performed by a UE (e.g., 111-116 as illustrated in FIG. 1). An embodiment of the method 700 shown in FIG. 7 is for illustration only. One or more of the components illustrated in FIG. 7 can be implemented in specialized circuitry configured to perform the noted functions or one or more of the components can be implemented by one or more processors executing instructions to perform the noted functions.

FIG. 6 and FIG. 7 describe one example of embodiments how the UE controls measurements on serving cell and/or neighboring cell with SSB and LP-WUS. Note here LP-WUS means only the serving cell's LP-WUS. FIG. 6 describes an example of the signaling flows between the UE and the serving gNB. 601 indicates the UE that also supports synchronization and measurement based on LP-WUS in addition to synchronization and measurement based on SSB. The UE, for example, is in an RRC idle/inactive state. However, the embodiment can be also applicable to the RRC connected UE. 605 indicates the gNB that controls the serving cell of the 601 UE. 611 indicates the serving cell's LP-WUS configuration (e.g., resource information in frequency and/or time domain, LP-WUS sequence code related information, etc.), threshold#1, threshold#2, threshold#3, timer#1, timer#2, and/or the existing parameters for measurement rules that already described are transmitted via system information.

Note that system information may not configure all of them. Once the UE receives 611 system information, in 621 the UE performs synchronization and/or measurement on LP-WUS and SSB according to the measurement rule, which is described in FIG. 7. Note if the UE is in an RRC connected state, instead of system information, a UE dedicated RRC message can be used to configure LP-WUS and the corresponding measurement control in 611.

FIG. 7 describes an example of the flow-chart of the UE behaviors. 701 indicates the UE has received LP-WUS configuration, threshold#1, threshold#2, threshold#3, timer#1, timer#2 and/or the existing parameters for measurement rules via system information (SI). Note the UE can receive some of them via system information, e.g., the serving cell's LP-WUS configuration, threshold#1, threshold#2, threshold#3 and the existing parameters for measurement rules, or LP-WUS configuration, timer#1, timer#2 and the existing parameters for measurement rules, or any other combinations. Then the UE monitors LP-WUS, and performs synchronization and/or measurement based on LP-WUS. Note once the UE performs synchronization and/or measurement based on LP-WUS, the UE may not perform synchronization and/or measurement based on SSB.

Alternatively, as described in 751, the UE monitors LP-WUS and performs synchronization and/or measurement (711) based on LP-WUS if 751 condition is met (Yes), otherwise the UE performs synchronization and/or measurement based on SSB (731).

Assuming threshold#1, threshold#2 and threshold#3 are configured in 701, the UE checks if the measured result from 711 is (equal or) worse than threshold#1 in 721. An example of the measured result can be the measured RSRP and/or RSRQ on LP-WUS. If both measured RSRP and RSRQ based on LP-WUS is used, separate thresholds can be configured for RSRP and RSRQ in 701, e.g. threshold#1-A, threshold#1-B, and if {measured RSRP based on LP-WUS is (equal or) worse than threshold#1-A} and/or {measured RSRQ based on LP-WUS is (equal or) worse than threshold#1-B}, then 721 condition is met. Alternatively, the UE can check if a kind of equation based on measured result from 711 is (equal or) worse than threshold#1. As an example, a similar equation such as Srxlev and/or Squal can be used. Note that, in the case, its RSRP and/or RSRQ is derived from the measured result based on LP-WUS and possibly separate offset and/or threshold can be configured/used in the equation (in addition to the ones that used in the current Srxlev and/or Squal equation).

Note that using common offset and/or threshold that is used in the current Srxlev and/or Squal is not excluded. If different equations are used for RSRP and RSRQ (like Srxlev based on RSRP and Squal based on RSRQ), separate thresholds can be configured for the equations, e.g. threshold#1-A, threshold#1-B, and if {the equation based on the measured RSRP on LP-WUS is (equal or) worse than threshold#1-A} and/or { the equation based on the measured RSRQ on LP-WUS is (equal or) worse than threshold#1-B}, then 721 condition is met. If the measured result (or the equation based on the measured result) on LP-WUS is not (equal or) worse than threshold#1(i.e., if 721 condition is not met), the UE continues performing synchronization and/or measurement only based on LP-WUS (711).

If the measured result (or the equation based on the measured result) on LP-WUS is (equal or) worse than threshold#1 (i.e., if 721 condition is met), the UE performs synchronization and/or measurement based on serving's cell SSB in 731. Once the UE starts performing synchronization and/or measurement on serving cell's SSB in 731, the UE applies the existing measurement rules for neighboring cells' measurements, which is based on the measured result on the serving cell's SSB in 741.

Note in 731, the UE can perform synchronization and/or measurement on the serving cell's SSB only (i.e., not performing synchronization and/or measurement based on LP-WUS and/or not performing monitoring/reception of LP-WUS). Alternatively, the UE can perform synchronization and/or measurement based on the serving cell's SSB in addition to synchronization and/or measurement based on LP-WUS. Once the UE has performed synchronization and/or measurement based on the serving cell's SSB in 731, the UE checks if Srxlev that is derived based on the measured result on the SSB is (equal or) better than threshold#2 in 751. If Srxlev that is derived based on the measured result on the SSB is (equal or) better than threshold#2 (i.e., if 751 condition is met), the UE switches back to performing synchronization and/or measurement only based on LP-WUS in 711. If Srxlev that is derived based on the measured result on the SSB is not (equal or) better than threshold#2 (i.e., if 751 condition is not met), the UE keeps performing synchronization and/or measurement on the serving cell's SSB and/or neighboring cells' SSB in 731 and 741.

In 751, alternatively, the UE can check if {(Srxlev that is derived based on the measured result on the SSB is better than threshold#2) and/or (Squal that is derived based on the measured result on the SSB is better than threshold#3)}. If the condition is met, the UE switches back to performing synchronization and/or measurement only based on LP-WUS in 711, otherwise the UE keeps performing synchronization and/or measurement on the serving cell's SSB and/or neighboring cells' SSB in 731 and 741. Assuming timer#1 and timer#2 are configured in 701, the UE performs synchronization and/or measurement based on LP-WUS during the time period when timer#1 runs in 711. If timer#1 expires/stops, the UE stops performing synchronization and/or measurement based on LP-WUS. The UE performs synchronization and/or measurement based on the serving cell's SSB and/or neighboring cells' SSB in 731 and 741 during the time period when timer#2 runs.

If timer#2 expires/stops, the UE stops performing synchronization and/or measurement based on the serving cell's SSB. Alternatively, single timer (e.g. timer#1) can be used for switching between performing synchronization and/or measurement based on LP-WUS and based on the serving cell's SSB. For example, if timer#1 runs, the UE performs synchronization and/or measurement based on LP-WUS and if timer#1 expires/stops, the UE performs synchronization and/or measurement based on the serving cell's SSB.

Alternatively, the timing information (e.g., System Frame Number (SFN), subframe number, slot number, time duration to perform synchronization and/or measurement based on either LP-WUS or the serving cell's SSB, time interval between two consecutive time duration, and/or offset to indicate the starting time for the first time duration, etc.) indicating when the UE performs synchronization and/or measurement based on LP-WUS and when the UE performs synchronization and/or measurement on the serving cell's SSB can be configured/used. Note thresholds and timers can be used together. For example, if threshold#1, threshold#2, threshold#3, timer#1 and timer#2 are configured, the UE performs synchronization and/or measurement only based on LP-WUS in 711 unless either {the measured result (or the equation based on measured result) on LP-WUS is (equal or) worse than threshold#1} or {timer#1 expires/stops} is met (i.e., the UE performs synchronization and/or measurement only based on LP-WUS in 711 when both {the measured result (or the equation based on measured result) on LP-WUS is better than threshold#1} and {timer#1 runs} are met). The UE switches to performing synchronization and/or measurement on the serving cell's SSB and/or neighboring cells' SSB in 731 and 741 when either {the measured result (or the equation based on measured result) from LP-WUS is (equal or) worse than threshold#1} or {timer#2 runs} is met.

And then the UE switches back to performing synchronization and/or measurement only based on LP-WUS in 711 when both {Srxlev (and Squal) that is derived based on the measured result on the serving cell's SSB is better than threshold#2 (and threshold#3)} and {timer#2 expires/stops} are met. Note timer#1 can be started when the UE triggers performing synchronization and/or measurement based on LP-WUS in 711 and timer#2 can be started when the UE triggers performing synchronization and/or measurement on the serving cell's SSB in 731.

Alternatively, the UE can trigger performing synchronization and/or measurement based on LP-WUS in 711 when timer#1 is started (if timing for timer#1 (re)starting and stopping is semi-statically configured, e.g., by SFN, subframe number, slot number, timer#1 time duration, timer interval between two consecutive timer#1 time durations, and/or offset to indicate the time instance to run the first timer#1) and the UE can trigger performing synchronization and/or measurement on the serving cell's SSB in 731 when timer#2 is started (if timing for timer#2 (re)starting and stopping is semi-statically configured, e.g., by SFN, subframe number, slot number, timer#2 time duration, timer interval between two consecutive timer#2 time durations, and/or offset to indicate the time instance to run the first timer#2).

As another example for the combination of threshold(s) and timer(s), if the UE switches from performing synchronization and/or measurement based on LP-WUS to performing synchronization and/or measurement based on the serving cell's SSB, based on the measured result on LP-WUS and the configured threshold (e.g. if 721 condition is met in FIG. 7), the UE starts the configured timer(s) for the previous signal (LP-WUS) and performs synchronization and/or measurement based on the previous signal (LP-WUS) during the time period when the timer runs, in addition to the synchronization and/or measurement based on the serving cell's SSB in 731. With the additional measurement on LP-WUS to the timer, the UE can check 721 condition in the FIG. 7 and if 721 condition is not met (i.e., No in 721 condition), the UE performs synchronization and/or measurement only based on LP-WUS (without performing synchronization and/or measurement based on the serving cell's SSB).

The example above is when the UE switches from performing synchronization and/or measurement based on LP-WUS to performing synchronization and/or measurement based on the serving cell's SSB, however it can be also applied when the UE switches from performing synchronization and/or measurement based on the serving cell's SSB to performing synchronization and/or measurement based on LP-WUS. As another example, the UE can detect its context (ex: stationary, driving, apps being used etc.). Based on the context, the UE can adjust measurement strategy, and/or thresholds. For example, when the UE is stationary and is engaged in low data task, the UE can rely on LP-WUS to maintain the connection while saving energy. But when the UE is engaged in high data task (ex: streaming) and/or driving, UE may want a detailed measurement, hence may need SSB. Also, the UE may adaptively adjust the thresholds for switching between LP-WUS and SSB, for example, when UE determines that it's in a poor signal quality area (based on historical measurements), it can lower the threshold for switching to SSB. Alternatively, based on user preference LP-WUS is disabled (for this user, performance is of higher priority; does not care for battery life).

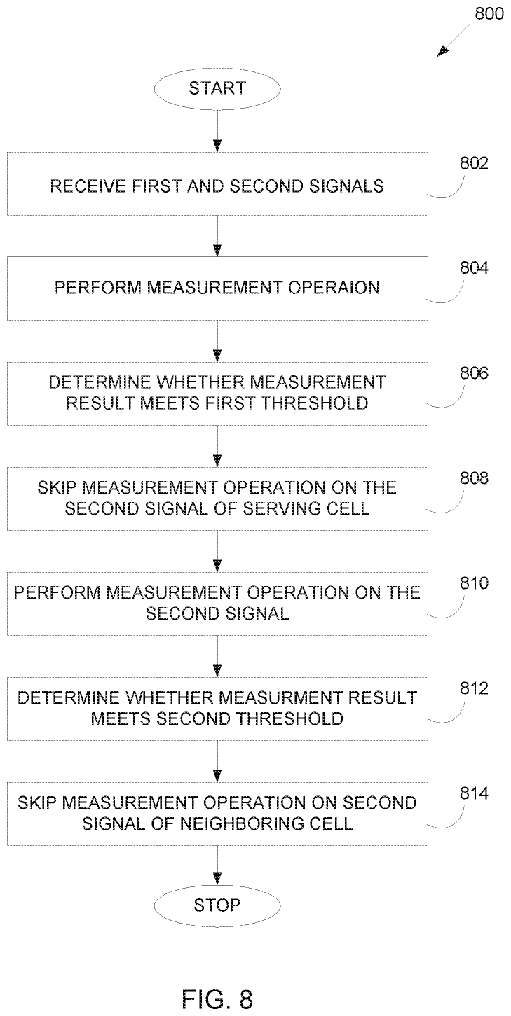

FIG. 8 illustrates a flowchart of a UE method 800 for a measurement control with low power signals in a wireless communication system. The method 800 as may be performed by a UE (e.g., 111-116 as illustrated in FIG. 1). An embodiment of the method 800 shown in FIG. 8 is for illustration only. One or more of the components illustrated in FIG. 8 can be implemented in specialized circuitry configured to perform the noted functions or one or more of the components can be implemented by one or more processors executing instructions to perform the noted functions.

As illustrate in FIG. 8, the method 800 begins at step 802. In step 802, a UE receives, from a BS of a serving cell, a first signal and a second signal.

In step 802, the first signal of the serving cell is a LP-WUS and the second signal of the serving cell is an SSB.

In step 804, the UE performs a measurement operation on the first signal of the serving cell. In step 806, the UE determines whether a measurement result of the first signal meets a first threshold. In step 808, the UE, based on a determination that the measurement result of the first signal meets the first threshold, skips the measurement operation on the second signal of the serving cell.

In step 810, the UE, based on a determination that the measurement result of the first signal does not meet the first threshold, performing a measurement operation on the second signal of the serving cell. In step 812, the UE determines whether a measurement result of the second signal meets a second threshold. In step 814, the UE, based on a determination that the measurement result of the second signal of the serving cell meets the second threshold, skips a measurement operation on a signal of a neighboring cell. In 814, the signal of the neighboring cell is the SSB.

In one embodiment, the UE receives, from the BS, system information including the first threshold for the first signal and the second threshold for the second signal.

In one embodiment, the UE, when the measurement operation on the second signal of the serving cell is initiated, performs the measurement operation on the first and second signals of the serving cell or performs the measurement operation on the second signal of the serving cell.

In one embodiment, the UE receives system information including a third threshold and, when a measurement result of the second signal of the serving cell meets the third threshold, switches from the measurement operation on the second signal of the serving cell to the measurement operation on the first signal of the serving cell.

In one embodiment, the UE receives, from the BS, system information including a first timer and a second timer for the measurement operation.

In one embodiment, the UE performs the measurement operation on the first signal of the serving cell until the first timer expires and initiates the measurement operation on the second signal of the serving cell after the first timer expires.

In one embodiment, the UE performs the measurement operation on the second signal of the serving cell until the second timer expires and initiates the measurement operation on the first signal of the serving cell after the second timer expires.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A user equipment (UE) in a wireless communication system, the UE comprising:
a transceiver configured to receive, from a base station (BS) of a serving cell, a first signal and a second signal, and
a processor operably coupled to the transceiver, the processor configured to:
perform a measurement operation on the first signal of the serving cell,
determine whether a measurement result of the first signal meets a first threshold,
based on a determination that the measurement result of the first signal meets the first threshold, skip the measurement operation on the second signal of the serving cell, and
based on a determination that the measurement result of the first signal does not meet the first threshold:
perform a measurement operation on the second signal of the serving cell,
determine whether a measurement result of the second signal meets a second threshold, and
based on a determination that the measurement result of the second signal of the serving cell meets the second threshold, skip a measurement operation on a signal of a neighboring cell.

2. The UE of claim 1, wherein:
the first signal of the serving cell is a low power-wake-up-signal (LP-WUS);
the second signal of the serving cell is a synchronization signal/physical broadcasting channel block (SSB); and
the signal of the neighboring cell is the SSB.

3. The UE of claim 1, wherein the transceiver is further configured to receive, from the BS, system information including the first threshold for the first signal and the second threshold for the second signal.

4. The UE of claim 1, wherein, when the measurement operation on the second signal of the serving cell is initiated, the processor is further configured to:
perform the measurement operation on the first and second signals of the serving cell; or
perform the measurement operation on the second signal of the serving cell.

5. The UE of claim 1, wherein:
the transceiver is further configured to receive system information including a third threshold; and
when a measurement result of the second signal of the serving cell meets the third threshold, the processor is further configured to switch from the measurement operation on the second signal of the serving cell to the measurement operation on the first signal of the serving cell.

6. The UE of claim 1, wherein the transceiver is further configured to receive, from the BS, system information including a first timer and a second timer for the measurement operation.

7. The UE of claim 6, wherein the processor is further configured to:
perform the measurement operation on the first signal of the serving cell until the first timer expires; and
initiate the measurement operation on the second signal of the serving cell after the first timer expires.

8. The UE of claim 6, wherein the processor is further configured to:
perform the measurement operation on the second signal of the serving cell until the second timer expires; and
initiate the measurement operation on the first signal of the serving cell after the second timer expires.

9. A method of a user equipment (UE) in a wireless communication system, the method comprising:
receiving, from a base station (BS) of a serving cell, a first signal and a second signal;
performing a measurement operation on the first signal of the serving cell; and
determining whether a measurement result of the first signal meets a first threshold:
based on a determination that the measurement result of the first signal meets the first threshold, skipping the measurement operation on the second signal of the serving cell, and
based on a determination that the measurement result of the first signal does not meet the first threshold:
performing a measurement operation on the second signal of the serving cell,
determining whether a measurement result of the second signal meets a second threshold, and
based on a determination that the measurement result of the second signal of the serving cell meets the second threshold, skipping a measurement operation on a signal of a neighboring cell.

10. The method of claim 9, wherein:
the first signal of the serving cell is a low power-wake-up-signal (LP-WUS);
the second signal of the serving cell is a synchronization signal/physical broadcasting channel block (SSB); and
the signal of the neighboring cell is the SSB.

11. The method of claim 9, further comprising receiving, from the BS, system information including the first threshold for the first signal and the second threshold for the second signal.

12. The method of claim 9, further comprising, when the measurement operation on the second signal of the serving cell is initiated:
performing the measurement operation on the first and second signals of the serving cell; or
performing the measurement operation on the second signal of the serving cell.

13. The method of claim 9, further comprising:
receiving system information including a third threshold; and
when a measurement result of the second signal of the serving cell meets the third threshold, switching from the measurement operation on the second signal of the serving cell to the measurement operation on the first signal of the serving cell.

14. The method of claim 9, further comprising receiving, from the BS, system information including a first timer and a second timer for the measurement operation.

15. The method of claim 14, further comprising:
performing the measurement operation on the first signal of the serving cell until the first timer expires; and
initiating the measurement operation on the second signal of the serving cell after the first timer expires.

16. The method of claim 14, further comprising:
performing the measurement operation on the second signal of the serving cell until the second timer expires; and
initiating the measurement operation on the first signal of the serving cell after the second timer expires.

17. A base station (BS) in a wireless communication system, the BS comprising:
a processor; and
a transceiver operably coupled to the processor the transceiver configured to transmit, to a user equipment (UE), a first signal and a second signal,
wherein:
a measurement operation is performed on the first signal of a serving cell including the BS,
whether a measurement result of the first signal meets a first threshold is determined,
based on a determination that the measurement result of the first signal meets the first threshold, the measurement operation is skipped on the second signal of the serving cell, and
based on a determination that the measurement result of the first signal does not meet the first threshold:
a measurement operation is performed on the second signal of the serving cell,
whether a measurement result of the second signal meets a second threshold is determined, and
based on a determination that the measurement result of the second signal of the serving cell meets the second threshold, a measurement operation is skipped on a signal of a neighboring cell.

18. The BS of claim 17, wherein:
the first signal of the serving cell is a low power-wake-up-signal (LP-WUS); and
the second signal of the serving cell is a synchronization signal/physical broadcasting channel block (SSB).

19. The BS of claim 17, wherein the signal of the neighboring cell is the LP-WUS.

20. The BS of claim 17, wherein the transceiver is further configured to transmit, to the UE, system information including at least one of:
the first threshold for the first signal and the second threshold for the second signal;
a third threshold; and
a first timer and a second timer for the measurement operation.
